(19) United States
(12) Patent Application Publication
(10) Pub. No.: US 2016/0064855 A1
(43) Pub. Date: Mar. 3, 2016

(54) DISPLAY CONNECTOR

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: SHI-CHAO WANG, Wuhan (CN)

(21) Appl. No.: 14/512,932

(22) Filed: Oct. 13, 2014

(30) Foreign Application Priority Data
Sep. 1, 2014 (CN) 201410439535.9

(51) Int. Cl. H01R 13/62; H01R 13/24

(52) U.S. Cl. CPC H01R 13/6205; H01R 13/2407

(57) ABSTRACT

A display connector includes a female connector and a male connector. The female connector is connected to a display card. The male connector is connected to an image output device. The female connector and the male connector each include an insulated main body, a plurality of connecting pins mounted on the main body, and an adsorption structure. The connecting pins of the male and female connectors are connected to each other by the adsorption of the adsorption structures of the male and female connectors.

### FIELD

The disclosure relates to a display connector, and particularly relates to a display connector based on planar adsorption.

### BACKGROUND

A display connector is used for connecting a display card to an image output device, such as a display or a television.

### BRIEF DESCRIPTION OF THE DRAWINGS

Implementations of the present technology will now be described, by way of example only, with reference to the attached figures, wherein:

FIG. 1 is an isometric, exploded view of a display connector in accordance with an exemplary embodiment of the present disclosure, wherein the display connector includes a female connector and a male connector.

FIG. 2 is an assembled, lateral view of the display connector in FIG. 1.

FIG. 3 is a lateral view of the female connector in FIG. 1.

FIG. 4 is an isometric view of the male connector in another aspect in FIG. 1.

FIG. 5 is a lateral view of the male connector in FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A display connector 100 in the present disclosure can be any kind of display connector, such as a display port connector, a high definition multimedia connector, a video graphics array, and so on. In this embodiment, the display connector 100 is a display port connector.

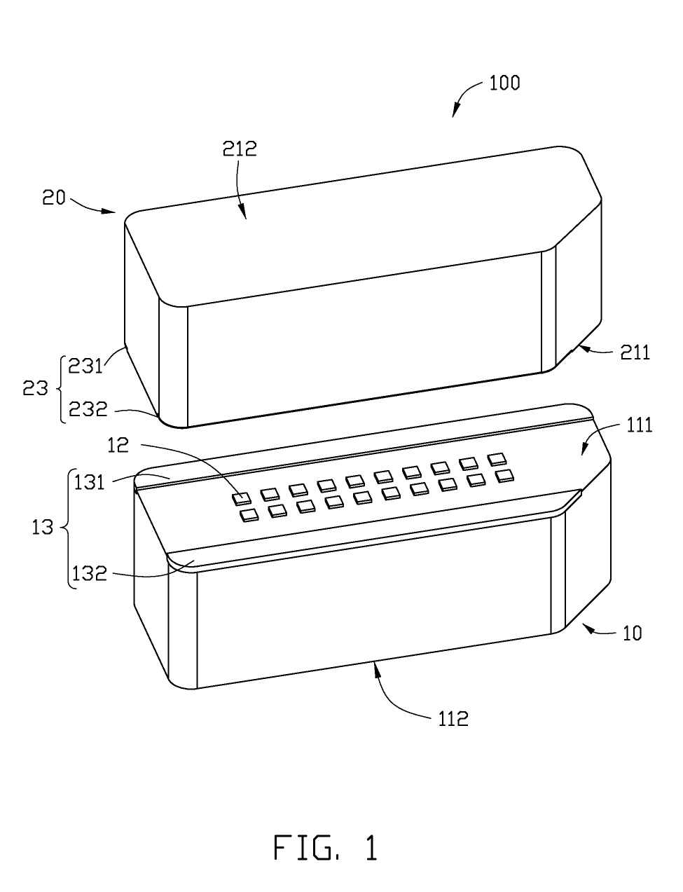

Referring to FIG. 1, the present display connector 100 includes a female connector 10 and a male connector 20. The female connector 10 is used for connecting a display card. The female connector 10 includes a main body 11, a plurality of connecting pins 12 arranged on the main body 11, and an adsorption structure 13.

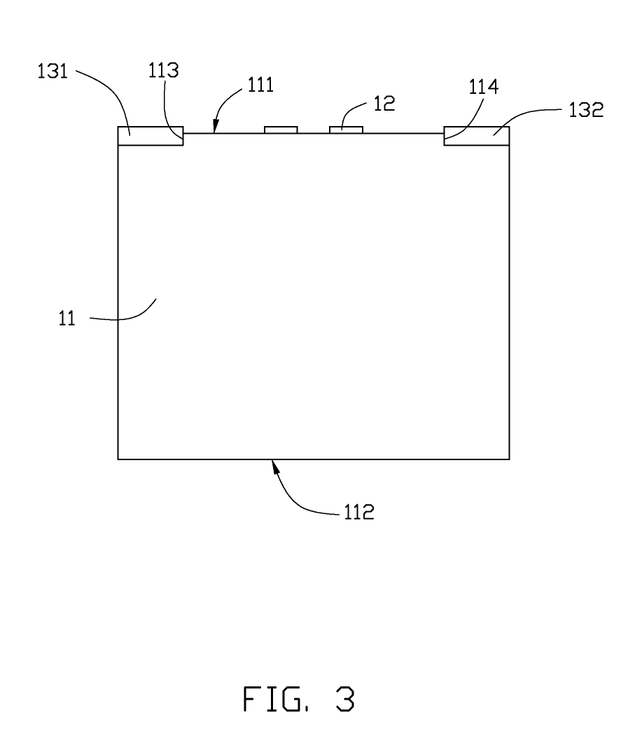

The main body 11 of the female connector 10 is made of electrical insulated material. In this embodiment, the main body 11 of the female connector 10 is made of plastic. A shape and size of the main body 11 of the female connector 10 are the same as that of a standard display port connector. Also referring to FIG. 3, the main body 11 of the female connector 10 includes an adsorption surface 111 and a concentrated surface 112. The adsorption surface 111 is substantially a rectangle with one corner truncated. In this embodiment, a size of the rectangle is 16 mm×4.8 mm. Each corner of the rectangle is chamfered. The adsorption structure 13 is made of adsorbent material. In this embodiment, the adsorption structure 13 includes a first permanent magnet 131 and a second permanent magnet 132. A first fixing area 113 and a second fixing area 114 are defined on the adsorption surface 111. The first fixing area 113 is used for fixing the first permanent magnet 131. The second fixing area 114 is used for fixing the second permanent magnet 132.

As shown in FIG. 3, in this embodiment, both of the first fixing area 113 and the second fixing area 114 are zonal grooves. The grooves are perpendicularly recessed from the absorption surface 111 to the main body 11 of the female connector 10. The first fixing area 113 and the second fixing area 114 are defined on two sides of the absorption surface 111, respectively. Lengths of the fixing areas 113 and 114 are the same with that of the main body 11. In other embodiments, the first fixing area 113 and the second fixing area 114 can also have other shapes. The first fixing area 113 and the second fixing area 114 can also be defined in other areas, such as two ends of the absorption surface 111.

Same as a standard display port connector, the number of the connecting pins 12 is 20. The connecting pins 12 are arranged on the absorption surface 111 of main body 11. The arrangement of the connecting pins 12 is the same as that of a standard display port connector. Each connecting pin 12 can be made of metallic materials. In this embodiment, each connecting pin 12 is made of copper. Each connecting pin 12 is passage for a separate signal. The connecting pin 12 has a capacity of elasticity. The connecting pins 12 penetrate through the main body 11, and exposed out of the absorption surface 111 of the main body 11 in an original state. Opposite ends of the connecting pins 12 are concentrated at the concentrated surface 112 to connect data lines (not shown). The connecting pin 12 can produce an elastic deformation under an external pressure. At this moment, each connecting pin 12 can retract into the main body 11. When the external pressure is withdrawn, the elastic deformation and the retraction of each connecting pin 12 restore to the original state. In this embodiment, the connecting pins 12 are quadrate and the top surfaces of the connecting pins 12 are coplanar. In other embodiments, the connecting pins 12 can also have other shapes.

In this embodiment, the concentrated surface 112 of the main body 11 is opposite to the absorption surface 111 of the main body 11. The concentrated surface 112 is a plane. In other embodiments, the concentrated surface 112 can also be other surfaces of the main body 11.

The size of the first permanent magnet 131 is equivalent to that of the first fixing area 113. The size of the second permanent magnet 132 is equivalent to that of the second fixing area 114. The first permanent magnet 131 and the second permanent magnet 132 are fixed in the first fixing area 113 and the second fixing area 114 of the main body 11, respectively. In this embodiment, the first permanent magnet 131 is N-type and the second permanent magnet 132 is S-type. In other embodiments, polarities of the first permanent magnet 131 and the second permanent magnet 132 can be interchanged. Both of the first permanent magnet 131 and the second permanent magnet 132 can be N-type or S-type.

Referring to FIG. 3, top surfaces of the first permanent magnet 131 and the second permanent magnet 132 are coplanar. In this embodiment, the first permanent magnet 131 and the second permanent magnet 132 protrude from the absorption surface 111 of the main body 11. The top surfaces of first and second permanent magnet 131, 132, and the top surfaces of the connecting pins 12 are in a same plane. In other embodiments, the top surfaces of first permanent magnet 131, the second permanent magnet 132 and the absorption surface 111 can be in a same plane. The first permanent magnet 131 and the second permanent magnet 132 can also be recessed from the absorption surface 111 to the main body 11. In other words, thicknesses of the first permanent magnet 131 and the second permanent magnet 132 can be less than heights of the first fixing area 113 and the second fixing area 114, respectively.

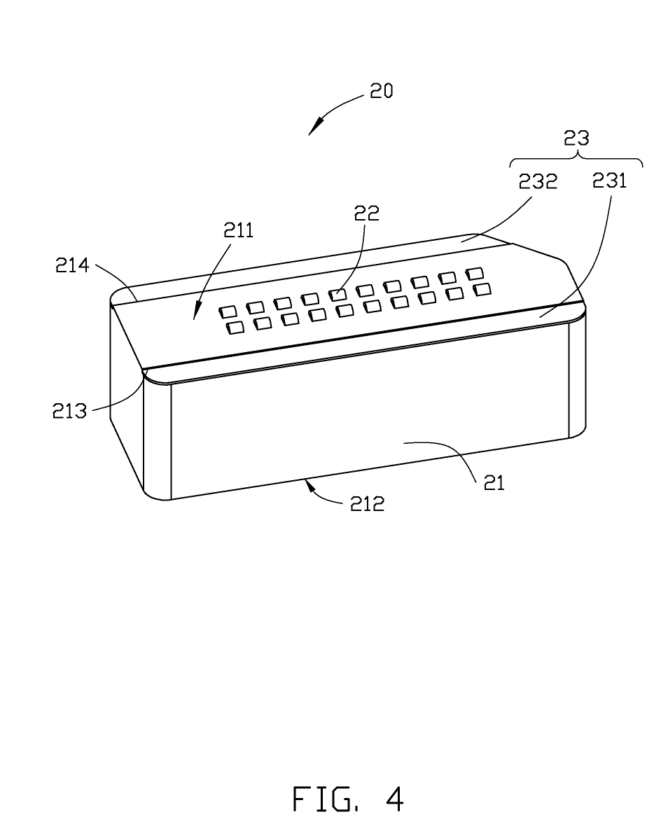

Referring to FIG. 4, the male connector 20 is used for connecting an image output devise. Similar to the female connector 10, the male connector 20 also includes a main body 21, a plurality of connecting pins 22 arranged on the main body 21 and an adsorption structure 23.

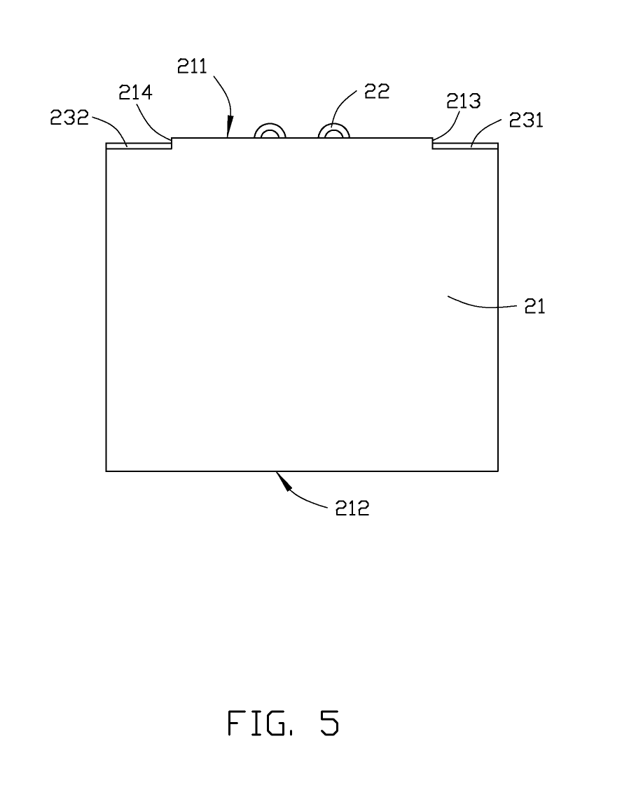

The main body 21 of the male connector 20 is made of electrical insulated material. In this embodiment, the main body 21 of the male connector 20 is made of plastic. A shape and size of the main body 21 of the male connector 20 are the same as that of the female connector 10. Also referring to FIG. 5, the main body 21 of the male connector 20 includes an adsorption surface 211 and a concentrated surface 212. The adsorption surface 211 is substantially a rectangle with one corner truncated. The truncated corner of the male connector 10 is substantially corresponding to the truncated corner of the female connector 10. In this embodiment, a size of the rectangle is 16 mm×4.8 mm. Each corner of the rectangle is chamfered. The adsorption structure 23 can be made of adsorbent material. The adsorption structure 23 of the male connector 20 can be tightly connected to the adsorption structure 13 of the female connector 10. In this embodiment, the adsorption structure 23 includes a first permanent magnet 231 and a second permanent magnet 232. A first fixing area 213 and a second fixing area 214 are defined on the adsorption surface 211. The first fixing area 213 is used for fixing the first permanent magnet 231. The second fixing area 214 is used for fixing the second permanent magnet 232. A size of the first fixing area 213 is the same with that of the first fixing area 113 of the female connector 10. A size of the second fixing area 214 is the same as that of the second fixing area 114 of the female connector 10.

As shown in FIG. 5, in this embodiment, both of the first fixing area 213 and the second fixing area 214 are zonal grooves. The grooves are perpendicularly recessed from the absorption surface 211 to the main body 21 of the male connector 20. The first fixing area 213 and the second fixing area 214 are defined on two sides of the absorption surface 211, respectively. Lengths of the fixing areas 213 and 214 are the same with that of the main body 11. In other embodiments, the first fixing area 213 and the second fixing area 214 can also have other shapes. The first fixing area 213 and the second fixing area 214 can also be defined in other areas, such as two ends of the absorption surface 211.

Same as the female connector 10, the number of the connecting pins 22 of the male connector 20 in this embodiment is 20. The connecting pins 22 are arranged on the absorption surface 211 of main body 21. The arrangement of the connecting pins 22 is substantially corresponding to that of the connecting pins 12 of the female connector 10. The connecting pins 22 can be made of metallic materials. In this embodiment, each connecting pin 22 is made of copper. Same as the connecting pins 12 of the female connector 10, each connecting pin 22 of the male connector 20 is passage for a separate signal. The connecting pin 22 has a capacity of elasticity. The connecting pins 22 penetrate through the main body 21, and exposed out of the absorption surface 211 of the main body 21 in an original state. Opposite ends of the connecting pins 22 are concentrated at the concentrated surface 212 to connect data lines (not shown). The connecting pin 22 can produce an elastic deformation under an external pressure. At this moment, each connecting pin 22 can retract into the main body 21. When the external pressure is withdrawn, the elastic deformation and the retraction of each connecting pin 22 restore to the original state. In this embodiment, the connecting pins 22 are semicircular. And the semicircle faces the absorption surface 211. In other embodiments, the connecting pins 22 can also have other shapes.

In this embodiment, the concentrated surface 212 of the main body 21 is opposite to the absorption surface 211 of the main body 21. The concentrated surface 212 is a plane. In other embodiments, the concentrated surface 212 can also be other surfaces of the main body 21.

The size of the first permanent magnet 231 is equivalent to that of the first fixing area 213. The size of the second permanent magnet 232 is equivalent to that of the second fixing area 214. The first permanent magnet 231 and the second permanent magnet 232 are fixed in the first fixing area 213 and the second fixing area 214 of the main body 21, respectively. A polarity of the first permanent magnet 231 of the male connector 20 is opposite to that of the first permanent magnet 131 of the female connector 10. A polarity of the second permanent magnet 232 of the male connector 20 is opposite to that of the second permanent magnet 132 of the female connector 10. In this embodiment, the first permanent magnet 231 is S-type and the second permanent magnet 232 is N-type. In other embodiments, corresponding to that of the female connector 10, polarities of the first permanent magnet 231 and the second permanent magnet 232 can be interchanged. Both of the first permanent magnet 231 and the second permanent magnet 232 can be S-type or N-type.

Referring to FIG. 5, top surfaces of the first permanent magnet 231 and the second permanent magnet 232 are coplanar. In this embodiment, the first permanent magnet 231 and the second permanent magnet 232 are slightly recessed from the absorption surface 211 of the main body 21. In other words, thicknesses of the first permanent magnet 231 and the second permanent magnet 232 are less than heights of the first fixing area 213 and the second fixing area 214, respectively. In other embodiments, the top surfaces of first permanent magnet 231, the second permanent magnet 232 and the absorption surface 211 can be in a same plane. The first permanent magnet 231 and the second permanent magnet 232 can also be protuberant from the absorption surface 211 of the main body 21.

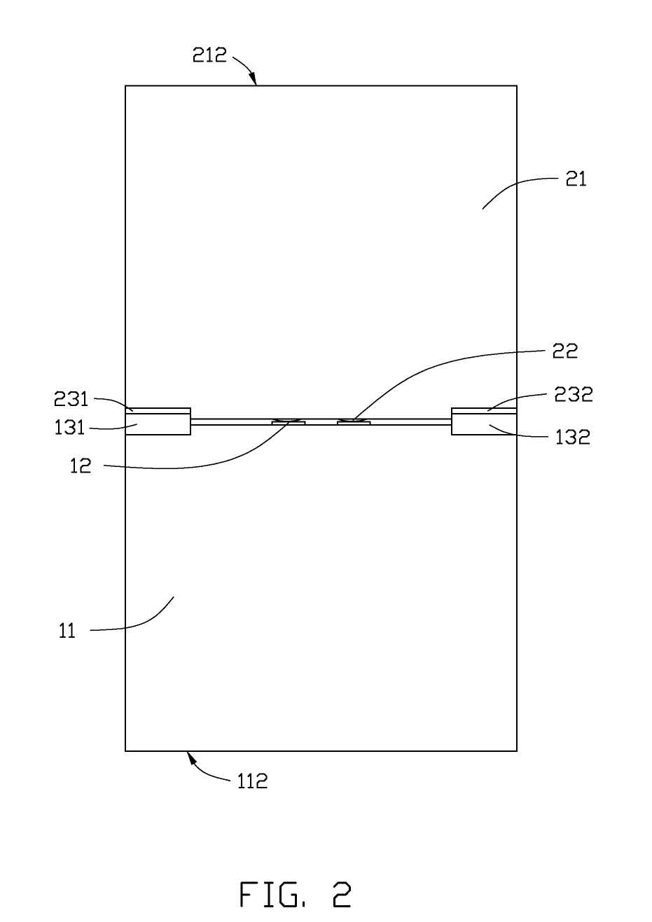

Referring to FIG. 1 and FIG. 2, when the display connector 100 in the present disclosure is assembled, the female connector 10 is engaged to the male connector 20. The absorption surface 211 of the male connector 20 faces the absorption surface 111 of the female connector 10. The first permanent magnet 231 of the male connector 20 is attached to the first permanent magnet 131 of the female connector 10. The second permanent magnet 232 of the male connector 20 is attached to the second permanent magnet 132 of the female connector 10. The connecting pins 22 of the male connector 20 are attached to the connecting pins 12 of the female connector 10 intimately with an elastic deformation.

When the display connector 100 in the present disclosure is in operation: the female connector 10 is connected to a display card. The male connector 20 is connected to an image output device. A signal of the display card transmits to the connecting pins 12 of the female connector 10 through the data lines on the concentrated surface 112. The signal from the connecting pins 12 of the female connector 10 transmits to the connecting pins 22 of the male connector 20. And then the signal transmits to the data lines on the concentrated surface 212 of the male connector 20. The signal at last transmits to the image output device through the data lines on the concentrated surface 212.

Compared to the traditional connectors, the display connector 100 in the present disclosure is not assembled in an insert mode. The display connector 100 is designed in a coplanar type. The male connector 20 is connected to the female connector 10 through an adsorption action between different absorption structures 23, 13, whereby a connecting abrasion is avoided.

Further, the absorption surface 111 of the female connector 10 and the absorption surface 211 of the male connector 20 are planes. The connecting pins 12 of the female connector 10 and the connecting pins 22 of the male connector 20 are exposed out of the main body 11, 21, respectively. The connecting pins 12 of the female connector 10 can connect to the connecting pins 22 of the male connector 20 more conveniently.

The embodiment shown and described above is only an example. Many details are often found in the art such as the other features of a tube. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A display connector, comprising a female connector and a male connector, the female connector and the male connector each comprising an insulated main body, a plurality of connecting pins arranged on the main body, and an adsorption structure, wherein the connecting pins of the male and female connectors are connected to each other by the absorption structures of the male and female connectors.

2. The display connector of claim 1, wherein the female connector is adapted for connecting to a display card, the male connector is adapted for connecting to an image output device.

3. The display connector of claim 1, wherein the main body comprises an absorption surface and an opposite concentrated surface, and the adsorption structure comprises a first permanent magnet and a second permanent magnet positioned on the absorption surface of the main body.

4. The display connector of claim 3, wherein a first fixing area and a second fixing area are defined on two sides of the absorption surface, the first fixing area is used for fixing the first permanent magnet, and the second fixing area is used for fixing the second permanent magnet.

5. The display connector of claim 4, wherein the first fixing area and the second fixing area are zonal grooves.

6. The display connector of claim 5, wherein lengths of the first fixing area and the second fixing area are equal to that of the main body.

7. The display connector of claim 6, wherein the first fixing area and the second fixing area are perpendicularly recessed from the absorption surface to the concentrated surface.

8. The display connector of claim 2, wherein top surfaces of the first permanent magnet and the second permanent magnet are coplanar.

9. The display connector of claim 8, wherein the first permanent magnet and the second permanent magnet of the female connector protrude from the absorption surface of the main body.

10. The display connector of claim 9, wherein thicknesses of the first permanent magnet and the second permanent magnet of the male connector are less than heights of the first fixing area and the second fixing area of the male connector.

11. The display connector of claim 3, wherein a polarity of the first permanent magnet of the male connector is opposite to that of the first permanent magnet of the female connector, and a polarity of the second permanent magnet of the male connector is opposite to that of the second permanent magnet of the female connector.

12. The display connector of claim 11, wherein the first permanent magnet of the male connector is connected to the first permanent magnet of the female connector, and the second permanent magnet of the male connector is connected to the second permanent magnet of the female connector.

13. The display connector of claim 3, wherein the connecting pins are made of metallic materials.

14. The display connector of claim 13, wherein the connecting pins are exposed out of the absorption surface of the main body.

15. The display connector of claim 14, wherein the absorption surface of the male connector faces the absorption surface of the female connector when the male and female connectors are engaged.

16. The display connector of claim 15, wherein each connecting pin has a capacity of elasticity, the connecting pins of the male and female connectors produce an elastic deformation under the adsorption of the adsorption structures.
